(19) United States
(12) Patent Application Publication
(10) Pub. No.: US 2026/0148396 A1
(43) Pub. Date: May 28, 2026

(54) IMAGE CONTENT ANALYSIS METHOD AND IMAGE ANALYSIS APPARATUS

(71) Applicant: VIVOTEK INC., New Taipei City (TW)

(72) Inventor: Cheng-Chieh Liu, New Taipei City (TW)

(73) Assignee: VIVOTEK INC., New Taipei City (TW)

(21) Appl. No.: 19/370,833

(22) Filed: Oct. 28, 2025

(30) Foreign Application Priority Data
Nov. 27, 2024 (TW) 113145899

(51) Int. Cl. G06T 7/44; G06T 7/00

(52) U.S. Cl. CPC G06T 7/44; G06T 7/97

(57) ABSTRACT

An image content analysis method is applied to an image analysis apparatus and includes acquiring an image, utilizing an edge detection technology to compute an edge density of the image, utilizing a texture detection technology to compute a texture richness of the image, and analyzing the edge density and the texture richness to generate a richness score of the image.

### BACKGROUND OF THE INVENTION

### 1. Field of the Invention

The present invention relates to an image content analysis method and a related image analysis apparatus, and more particularly, to an image content analysis method that can obtain image richness for other analytical applications and a related image analysis apparatus.

### 2. Description of the Prior Art

Conventional surveillance technology applies change detection to the public area for determining feature changes. For example, the surveillance apparatus is installed in the bus and captures two images before the vehicle departs and when the vehicle arrives at the terminal, and the feature difference between the two images is analyzed to perform an empty check. The surveillance apparatus analyzes change in the pedestrian or the luggage within the two images to determine whether the pedestrian is still on the bus or whether the luggage is left on the bus, which is interpreted as the foresaid empty check. However, the time span between departure and arrival is very large, and the two images captured inside the bus may be overexposed (for example, on the sunny day) or underexposed (for example, on the rainy day or at night) due to changes in the ambient climate; in this case, analyzing the two images via the same parameters results in significant errors.

### SUMMARY OF THE INVENTION

The present invention provides an image content analysis method that can obtain image richness for other analytical applications and a related image analysis apparatus for solving above drawbacks.

According to one embodiment, an image content analysis method is applied to an image analysis apparatus. The image content analysis method includes acquiring an image to compute an edge density of the image via an edge detection technology, computing a texture richness of the image via a texture detection technology, and analyzing the edge density and the texture richness to generate a richness score of the image.

According to another embodiment, an image analysis apparatus includes an operation processor adapted to acquire an image for computing an edge density of the image via an edge detection technology, compute a texture richness of the image via a texture detection technology, and analyze the edge density and the texture richness to generate a richness score of the image.

The image content analysis method and the image analysis apparatus of the present invention can preferably apply for an indoor scene with an outdoor light source, such as the empty check. The dynamic range of the image may be compressed when the exposure ratio during image capture is increased, but an image contrast may be decreased and a mid-tone of the image may generate noise. If the increase of the exposure ratio is limited, the image may still be partial overexposed or underexposed when the image is captured during the empty check. Therefore, the image content analysis method and the image analysis apparatus of the present invention can use the preset weight or the dynamic weight to balance the edge density and the texture richness, and find out the image with the highest richness score and the most suitable exposure ratio for execution of the empty check.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image analysis apparatus according to an embodiment of the present invention.

FIG. 2 is a flow chart of an image content analysis method according to a first embodiment of the present invention.

FIG. 3 is a diagram of the histogram H acquired by the image analysis apparatus and the image content analysis method according to the embodiment of the present invention.

FIG. 4 is a flow chart of the image content analysis method according to a second embodiment of the present invention.

### DETAILED DESCRIPTION

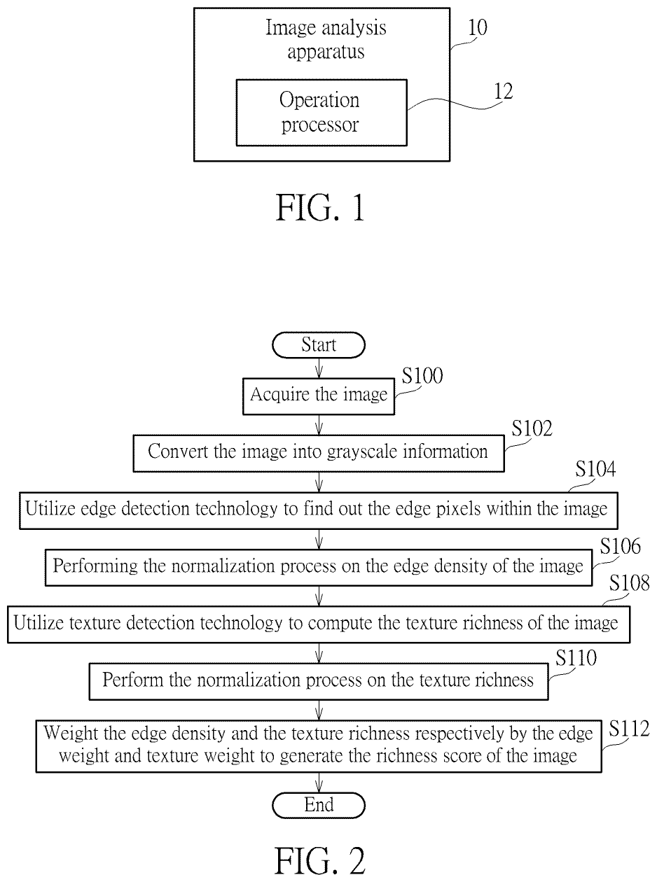

Please refer to FIG. 1 and FIG. 2. FIG. 1 is a functional block diagram of an image analysis apparatus 10 according to an embodiment of the present invention. FIG. 2 is a flow chart of an image content analysis method according to a first embodiment of the present invention. The image analysis apparatus 10 can at least include an operation processor 12 used to execute the image content analysis method of the present invention. The image analysis apparatus 10 can be an external device separated from a surveillance equipment, and can receive an image captured by the surveillance equipment in a wired manner or in a wireless manner for image analysis; further, the image analysis apparatus 10 may be a part of the surveillance equipment, and can receive the image from other element of the surveillance equipment for the image analysis. Relation between the image analysis apparatus 10 and the surveillance equipment is not limited to the foresaid embodiment, and depends on a design demand.

Regarding the image content analysis method of the first embodiment, step S100 and step S102 can be executed to acquire the image and convert the image into grayscale information. Then, step S104 and step S106 can be executed to analyze the grayscale information of the image via an edge detection technology to find out edge pixels Pₑ within the image, and compute a ratio of a number of the edge pixels Pₑ and a number of all pixels Pₜ of the image for performing a normalization process on an edge density E of the image, as formula 1. The edge detection technology can be defined as, but not be limited to, Canny edge detection algorithm, Sobel edge detection algorithm, Prewitt edge detection algorithm, or Laplacian edge detection algorithm.

Later, step S108 and step S110 can be executed to analyze the grayscale information of the image via a texture detection technology for computing a texture richness T of the image, and perform the normalization process on the texture richness T. The texture detection technology can be defined as, but not be limited to, local binary patterns, a histogram of oriented gradients (HOG), speeded-up robust features (SURF), Haar wavelets, and/or color histograms.

Final, step S112 can be executed to weight the edge density E and the texture richness T respectively by the edge weight ω_{E} and texture weight ω_{T} for generating a richness score R of the image, as formula 2. In the first embodiment, the sum of the edge weight ω_{E} and the texture weight ω_{T} can be preferably equal to 1, but an actual application is not limited thereto.

$$E = \frac{{P}_{e}}{{P}_{t}} \qquad Formula 1$$

$$R = {ω}_{E} \times E + {ω}_{T} \times T \qquad Formula 2$$

Regarding step S108 and step S110, the image content analysis method of the present invention can optionally apply the texture detection technology for all pixels of the image; or, the image content analysis method of the present invention may find out the edge pixels Pₑ, and apply the texture detection technology for a non-edge area (e.g., pixels other than the edge pixels Pₑ) of the image for computing the texture richness T, so as to decrease computation effort and effectively increase system performance. Besides, the image content analysis method of the present invention can acquire a comparison result of each pixel to an adjacent pixel in the grayscale information of the image to generate the local binary pattern LBP of the said pixel, as formula 3. Among them, the symbol “i” and the symbol “j” can be defined as coordinate information, the symbol “P” can be defined as a number of the adjacent pixels located around a central pixel in a circularly symmetrical manner, and the symbol “s k” can be defined as a binary value based on the comparison result of the central pixel to the kth adjacent pixel.

When the local binary pattern LBP of each pixel is acquired, the image content analysis method of the present invention can convert the local binary patterns LBP that correspond to all pixels within the image detected by the texture detection technology into a histogram H of the image, as formula 4. Among them, the symbol “B” can be defined as a possible number of the local binary pattern LBP, and the symbol “hᵢ” can be defined as an occurrence frequency of the i-th local binary pattern LBP. The image content analysis method of the present invention can further compute a normalization probability pᵢ of the local binary pattern LBP of each pixel, utilize the normalization probability pᵢ and a reference constant to generate an entropy, and further utilize the entropy and the possible number B of the local binary pattern LBP to perform the normalization process on the texture richness T, as formula 5, formula 6 and formula 7. Among them, the symbol “∈” can be defined as the reference constant, and an actual value of the reference constant can depend on the design demand.

$$LBP ( i , j ) = {\sum }_{k = 0}^{P - 1} {s}_{k} \cdot {2}^{k} \qquad Formula 3$$

$$H = \{ {h}_{0} , {h}_{1} , … , {h}_{B - 1} \} \qquad Formula 4$$

$${p}_{i} = \frac{{h}_{i}}{{\sum }_{j = 0}^{B - 1} {h}_{j}} \qquad Formula 5$$

$$Entropy = - {\sum }_{i = 0}^{B - 1} {p}_{i} {log}_{2} ( {p}_{i} + ϵ ) \qquad Formula 6$$

$$T = \frac{Entropy}{{log}_{2} ( B )} \qquad Formula 7$$

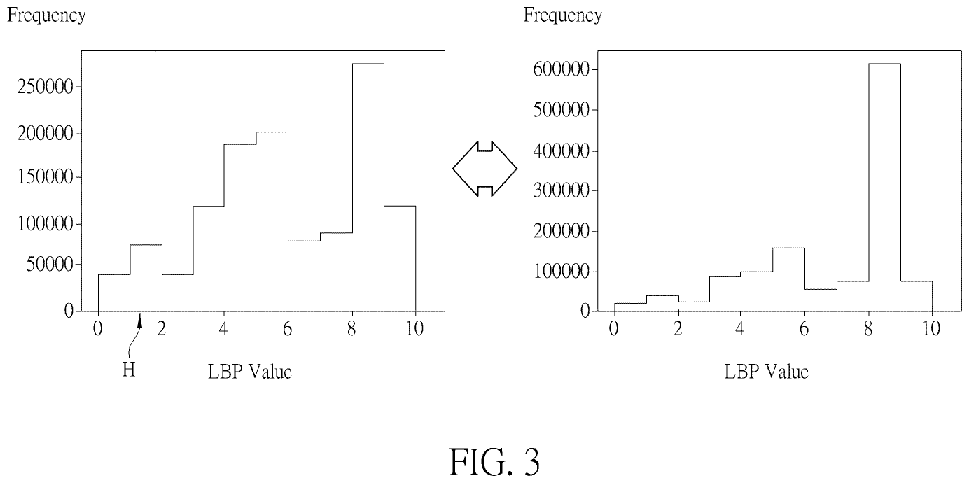

Please refer to FIG. 3. FIG. 3 is a diagram of the histogram H acquired by the image analysis apparatus 10 and the image content analysis method according to the embodiment of the present invention. As the histogram H shown in the left side of FIG. 3, the texture converted by the image content analysis method can be dispersed at different values, which indicates the texture of the image is more preserved so the image has the preferred texture richness T, and exposure quality of the image can be more suitable for the required application of the image analysis apparatus 10. As the histogram H shown in the right side of FIG. 3, the texture is concentrated at high values, which indicates less texture is preserved in the image, so the image has the poor texture richness T and is overexposed; it should be mentioned that the texture being concentrated at low values can be considered as the image is underexposed. Therefore, the image content analysis method of the present invention can combine two main indices to define the richness score R of the image. The image content analysis method can utilize the edge detection technology to acquire the edge density E (which can be interpreted as structural complexity) of the image, and utilizes the texture detection technology to compute the entropy of the local binary pattern LBP of the image, so as to generate the texture richness T for indicating texture change within the image, as shown in FIG. 3. The main indices (e.g., the edge density E and the texture richness T) can be processed by the normalization process to ensure the edge density E and the texture richness T are on the same benchmark and comparable, and the edge weight ω_{E} and the texture weight ω_{T} that are pre-defined can be utilized to aggregate the edge density E and the texture richness T for generating the final richness score R of the image.

The image analysis apparatus 10 of the present invention can preferably acquire one image before the vehicle departs and another image when the vehicle arrives at the terminal, and the foresaid two images can be applied for empty check of the bus or any public transportation vehicles, but the actual application is not limited thereto. The image content analysis method of the present invention can analyze and compute the richness score R of the image to adjust the exposure ratio of the image before the vehicle departs and when the vehicle arrives at the terminal, so as to acquire two images that are suitable for the empty check. The images acquired at other time can be automatically adjusted or recovered to an initial exposure ratio by the surveillance equipment. Therefore, the image analysis apparatus 10 of the present invention can compare the computed richness score R of one image with a richness reference value (e.g., a maximal richness score). When the richness score R of the image is greater than the richness reference value, the image can show preferred content details, and the image can be stored and the exposure ratio of the image can be compared with an exposure ratio reference value (e.g., a maximal exposure ratio). When the richness score R of the image is smaller than or equal to the richness reference value, the image may show less content details. The richness reference value and the exposure ratio reference value can be set based on a statistical value (e.g., a mean value) or an optimal value after iteration acquired by the image captured under a specific environment (e.g., interior space of a certain type of the public transportation vehicle in a certain area at a certain time).

When the exposure ratio of the image is smaller than the exposure ratio reference value, the image analysis apparatus 10 can increase the exposure ratio required for a capturing process, and compute the richness score R of a following image to reconfirm whether the exposure ratio required for the capturing process need to be adjusted again. When the exposure ratio of the image is greater than or equal to the exposure ratio reference value, the image analysis apparatus 10 can set the exposure ratio as an optimal exposure ratio suitable for capturing the image applied for the empty check, so that the image with the most suitable richness score R can be acquired accordingly. It should be mentioned that the image analysis apparatus 10 may preferably capture the image at the initial exposure ratio when the image is not applied for the empty check.

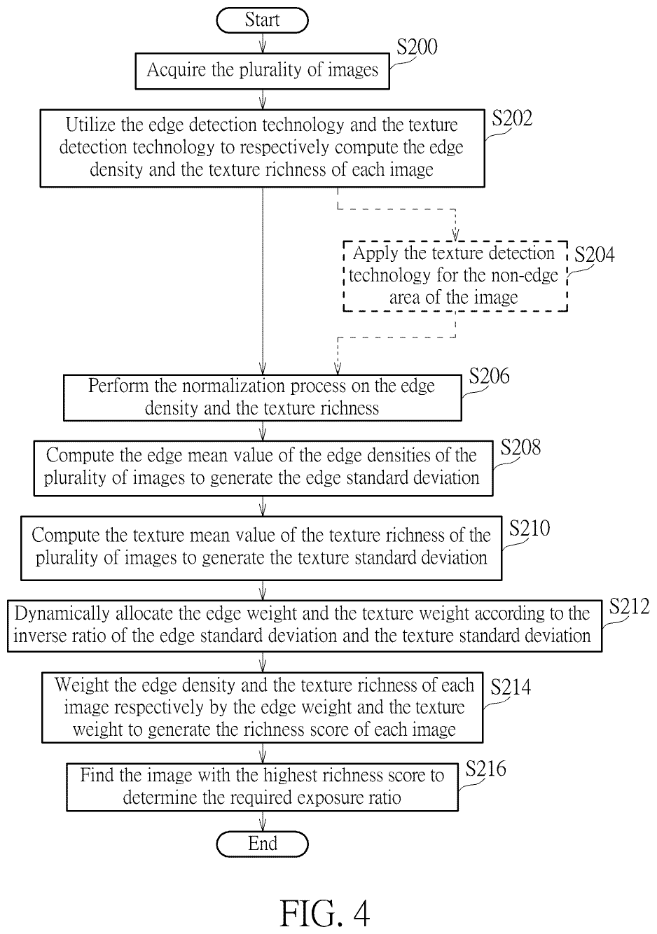

Please refer to FIG. 4. FIG. 4 is a flow chart of the image content analysis method according to a second embodiment of the present invention. The image content analysis method illustrated in FIG. 2 is used to evaluate the richness scores R of a plurality of images. First, step S200 and step S202 can be executed to acquire the plurality of images, and utilize the edge detection technology and the texture detection technology to respectively compute the edge density E and the texture richness T of each image. The edge density E and the texture richness T can be computed by using step S104 to step S110 of the first embodiment, and a detailed description is omitted herein for simplicity. Then, step S204 can be optionally executed to apply the texture detection technology for a non-edge area of the image. After that, step S206 can be executed to perform the normalization process on the edge density E and the texture richness T. Then, step S208, step S210 and step S212 can be executed to compute an edge mean value μ_{E} of the edge densities E of the plurality of images for generating an edge standard deviation σ_{E}, compute a texture mean value μ_{T} of the texture richness T of the plurality of images for generating a texture standard deviation σ_{T}, and dynamically allocate the edge weight ω_{E} and the texture weight ω_{T} in accordance with an inverse ratio of the edge standard deviation σ_{E} and the texture standard deviation σ_{T}, as formula 8 and formula 9.

$${σ}_{E} = \sqrt{\frac{1}{N} {\sum }_{i = 1}^{N} {( {E}_{i} - {μ}_{E} )}^{2}} , {σ}_{T} = \sqrt{\frac{1}{N} {\sum }_{i = 1}^{N} {( {T}_{i} - {μ}_{T} )}^{2}} \qquad Formula 8$$

$${ω}_{E} = \frac{{σ}_{T}}{{σ}_{E} + {σ}_{T}} , {ω}_{T} = \frac{{σ}_{T}}{{σ}_{E} + {σ}_{T}} \qquad Formula 9$$

In the second embodiment, step S208 can compute a mean value of the edge densities E of the plurality of images to generate the edge mean value μ_{E}, and step S210 can compute the mean value of the texture richness T of the plurality of images to generate the texture mean value μ_{T}. Further, step S212 can dynamically allocate weights that are inversely proportional to each index to corresponding indices (e.g., the edge density E and the texture richness T). Final, step S214 and step S216 can be executed to weight the edge density E and the texture richness T of each of the plurality of images respectively by the edge weight ω_{E} and the texture weight ω_{T} for generating the richness score R of each image, as formula 10, and find out the image with the highest richness score R to determine the required exposure ratio. The symbol “N” can be defined as a number of the plurality of images. The image content analysis method of the second embodiment can be used to evaluate the multiple images, and apply dynamic weighting for balancing the edge density E and the texture richness T in accordance with statistical properties of the edge pixels Pₑ and the local binary pattern LBP, so as to utilize the indices of the richness score R to find the image that is most suitable for the empty check and the related exposure ratio.

$${R}_{i} = {ω}_{E} \times {E}_{i} + {ω}_{T} \times {T}_{i} for i = 1 \sim N \qquad Formula 10$$

Moreover, regarding the above-mentioned content “find out the image with the highest richness score R to determine the required exposure ratio”, the image with the highest richness score R may be suitable for the image analysis, but not for human viewing. In the present invention, images for the human viewing (e.g., images recorded by the surveillance equipment and transmitted to a back-end for display) and the images with the highest richness score R applied for the image analysis can be transmitted separately (e.g., different image streams) and stored separately (e.g., different memories, memory cards, network video recorders) by using different manners.

In conclusion, the image content analysis method and the image analysis apparatus of the present invention can preferably apply for an indoor scene with an outdoor light source, such as the empty check. The dynamic range of the image may be compressed when the exposure ratio during image capture is increased, but an image contrast may be decreased and a mid-tone of the image may generate noise. If the increase of the exposure ratio is limited, the image may still be partial overexposed or underexposed when the image is captured during the empty check. Therefore, the image content analysis method and the image analysis apparatus of the present invention can use the preset weight or the dynamic weight to balance the edge density and the texture richness, and find out the image with the highest richness score and the most suitable exposure ratio for execution of the empty check.

Those skilled in the art will readily observe that numerous modifications and alterations of the device and method may be made while retaining the teachings of the invention. Accordingly, the above disclosure should be construed as limited only by the metes and bounds of the appended claims

What is claimed is:

1. An image content analysis method applied to an image analysis apparatus, the image content analysis method comprising:
an operation processor of the image analysis apparatus acquiring an image;
the operation processor computing an edge density of the image via an edge detection technology;
the operation processor computing a texture richness of the image via a texture detection technology; and
the operation processor analyzing the edge density and the texture richness to generate a richness score of the image.

2. The image content analysis method of claim 1, further comprising:
the operation processor computing a ratio of a number of edge pixels to a number of all pixels of the image for performing a normalization process on the edge density.

3. The image content analysis method of claim 1, further comprising:
the operation processor computing a local binary pattern of each pixel of grayscale information of the image to generate a corresponding histogram;
the operation processor computing a normalization probability of each local binary pattern to generate an entropy; and
the operation processor utilizing the entropy and a number of the local binary pattern to perform a normalization process on the texture richness.

4. The image content analysis method of claim 1, wherein the operation processor utilizes an edge weight and a texture weight to respectively weight the edge density and the texture richness, and a sum of the edge weight and a texture weight is equal to 1.

5. The image content analysis method of claim 1, further comprising:
the operation processor applying the texture detection technology for a non-edge area of the image to compute the texture richness.

6. The image content analysis method of claim 1, further comprising:
the operation processor acquiring a plurality of images and utilizing the edge detection technology and the texture detection technology to compute the edge density and the texture richness of each image.

7. The image content analysis method of claim 6, further comprising:
the operation processor setting an edge weight via difference of the edge densities of the plurality of images;
the operation processor setting a texture weight via difference of the texture richness of the plurality of images;
the operation processor weighting the edge density and the texture richness of each of the plurality of images respectively by the edge weight and the texture weight; and
the operation processor comparing weighting results of the plurality of images to determine an exposure ratio that is most suitable for the plurality of images.

8. The image content analysis method of claim 7, further comprising:
the operation processor computing an edge mean value of the edge densities of the plurality of images, and utilizing the edge mean value to compute an edge standard deviation of the edge densities of the plurality of images;
the operation processor computing a texture mean value of the texture richness of the plurality of images, and utilizing the texture mean value to compute a texture standard deviation of the texture richness of the plurality of images; and
the operation processor allocating the edge weight and the texture weight according to an inverse ratio of the edge standard deviation and the texture standard deviation.

9. The image content analysis method of claim 7, further comprising:
the operation processor computing the weighting results to generate the richness score of each of the plurality of images; and
the operation processor determining the required exposure ratio via an image with a highest richness score among the plurality of images.

10. An image analysis apparatus comprising:
an operation processor adapted to acquire an image, compute an edge density of the image via an edge detection technology, compute a texture richness of the image via a texture detection technology, and analyze the edge density and the texture richness to generate a richness score of the image.

11. The image analysis apparatus of claim 1, wherein the operation processor is adapted to further compute a ratio of a number of edge pixels to a number of all pixels of the image for performing a normalization process on the edge density.

12. The image analysis apparatus of claim 1, wherein the operation processor is adapted to further compute a local binary pattern of each pixel of grayscale information of the image for generating a corresponding histogram, compute a normalization probability of each local binary pattern to generate an entropy, and utilize the entropy and a number of the local binary pattern to perform a normalization process on the texture richness.

13. The image analysis apparatus of claim 1, wherein the operation processor is adapted to further utilize an edge weight and a texture weight to respectively weight the edge density and the texture richness, and a sum of the edge weight and a texture weight is equal to 1.

14. The image analysis apparatus of claim 1, wherein the operation processor is adapted to further apply the texture detection technology for a non-edge area of the image to compute the texture richness.

15. The image analysis apparatus of claim 1, wherein the operation processor is adapted to further acquire a plurality of images and utilize the edge detection technology and the texture detection technology to compute the edge density and the texture richness of each image.

16. The image analysis apparatus of claim 6, wherein the operation processor is adapted to further set an edge weight via difference of the edge densities of the plurality of images, set a texture weight via difference of the texture richness of the plurality of images, weight the edge density and the texture richness of each of the plurality of images respectively by the edge weight and the texture weight, and compare weighting results of the plurality of images for determining an exposure ratio that is most suitable for the plurality of images.

17. The image analysis apparatus of claim 7, wherein the operation processor is adapted to further compute an edge mean value of the edge densities of the plurality of images and utilize the edge mean value to compute an edge standard deviation of the edge densities of the plurality of images, compute a texture mean value of the texture richness of the plurality of images and utilize the texture mean value to compute a texture standard deviation of the texture richness of the plurality of images, and allocate the edge weight and the texture weight according to an inverse ratio of the edge standard deviation and the texture standard deviation.

18. The image analysis apparatus of claim 7, wherein the operation processor is adapted to further compute the weighting results for generating the richness score of each of the plurality of images, and determine the required exposure ratio via an image with the highest richness score among the plurality of images.
